(19) United States
(12) Patent Application Publication
(10) Pub. No.: US 2014/0317936 A1
(43) Pub. Date: Oct. 30, 2014

(54) RETRACTABLE TELESCOPING UTILITY KNIFE

(71) Applicant: Yuewei Wu, Ningbo (CN)

(72) Inventor: Yuewei Wu, Ningbo (CN)

(21) Appl. No.: 14/128,608

(22) PCT Filed: Jun. 22, 2011
(86) PCT No.: PCT/CN2011/076166

§ 371 Date: Jun. 30, 2014

(51) Int. Cl. B26B 1/08

(52) U.S. Cl. CPC B26B 1/08
USPC 30/162

(57) ABSTRACT

A retractable telescoping utility knife having a handle having a first cover and a second cover detachably coupling together, a blade shell telescopically slidable contained in the handle and having a first shell and a second shell detachably coupling together, a blade seat slidably contained in the blade shell, a blade having installation notches and installed on the blade seat, an actuator having a neck formed on the blade seat, a blade shell control mechanism, and a blade change means.

### BACKGROUND OF THE INVENTION

1. Field of the Invention

The invention relates to a retractable telescoping utility knife, and more particularly, to the utility knife a blade thereof is able to be readily changed and automatically retract into a telescopic blade shell after an actuator for controlling the blade being released.

2. Description of the Prior Art

Utility knife is a commonly used hand tool for cutting, e.g., wood, paper, leather, plastic panel, cord, and cardboard. A compact utility knife is disclosed in a United States patent application US 2009/0,193,665 A1 by Ranieri at al. The compact utility knife includes a blade holder slidably connected to a handle, a blade lock mechanism for controlling the blade holder, and a trapezoidal utility blade a majority thereof extending forwardly of a forwardmost point of the handle.

Extending the blade holder significantly increases an overall length of the knife such that the knife is comfortable to use when in the extended position and longitudinally compact when in the retracted position This kind of compact utility knife has such a drawback that the blade is not able to retract into the blade holder after use and not able to be readily changed when worn and dull. However, for such kind of compact utility knife, it is very difficult to apply some conventional blade retracting and/or changing skills to the knife since the structure of telescopic blade holder and handle. A telescoping compact utility knife having a retractable blade which will be safer and having a easy-to-change blade which is user friendlier has long been composed.

### BRIEF SUMMARY OF THE INVENTION

The main object of the invention is to provide a telescoping utility knife a blade of which is able to retract into a telescopic blade shell after a user of the knife releases an actuator for controlling the blade.

Another object of the invention is to provide a telescoping utility knife a blade of which is able to be changed easily.

In accordance with one aspect of the invention, there is provided a retractable telescoping utility knife having a handle having a first cover and a second cover detachably coupling together, a blade shell telescopically slidable contained in the handle and having a first shell and a second shell detachably coupling together, a blade seat slidably contained in the blade shell, a blade having installation notches and installed on the blade seat, an actuator having a neck formed on the blade seat, a blade shell control mechanism, and a blade change means. The first cover has a longitudinal side opening with at least one front recess and at least one rear recess, a first inner guiding groove, and a first top opening. The second cover has a second inner guiding groove and a second top opening The first shell has a first outer guiding bar which is slidably received in the first inner guiding groove of the first cover, a first top slit, and a front inner slope. The second shell has a second outer guiding bar which is slidably received in the second inner guiding groove of the second cover, a second top slit, and a side slit. The blade seat has a rear tail, a side protrusion sticking out of the side slit, and a blade seat return spring one end thereof is fixed to the blade seat and the other end thereof is fixed to an inner surface of the blade shell. The blade shell control mechanism has a button with at least one ear received in the front recess and the rear recess and a pair of positioning holes, a resilient member between the button and the first shell, and a pair of positioning poles formed on an outer surface of the first shell and each slidably received in one of the positioning holes. The blade changing means has a cross guiding groove defined in an inner surface of the second cover and cross to the second inner guiding groove, a cross slit defined in the second cover within the cross guiding groove, a latch slidable along the cross guiding groove and having a central slit, a latch button having a pair of resilient leg, and a blade installation plate. The blade installation plate has a rear end fixed to the blade seat and a front end having a side finger and a blade installation pillar which is able to engage with the notch of the blade.

These and other objectives, features, and advantages of the present invention will become apparent from the following detailed description, the accompanying drawings and the appended claims.

### BRIEF DESCRIPTION OF THE DRAWINGS

FIG. 1 is a side view of the preferred embodiment of the utility knife of the invention showing a blade shell being retracted.

FIG. 2 is an opposite side view showing the utility knife shown in FIG. 1.

FIG. 3 is a side view of the utility knife shown in FIG. 1 showing a fully extension of the blade shell thereof.

FIG. 4 is a side view of the utility knife shown in FIG. 1 showing a fully extension of a blade thereof.

FIG. 5 is an exploded perspective view of the utility knife shown in FIG. 1.

FIG. 6 is an exploded perspective partial view showing a first cover of the utility knife shown in FIG. 1.

FIG. 7 is an exploded perspective partial view showing a status of the utility knife shown in FIG. 1 when the blade shell is fully extended and the blade is fully retracted.

FIGS. 8a through 8c are exploded perspective partial views showing an extension of the blade of the utility knife shown in FIG. 1. And,

FIGS. 9a and 9b are exploded perspective partial views showing a changing of the blade of the utility knife shown in FIG. 1.

### DETAILED DESCRIPTION OF THE PREFERRED EMBODIMENT

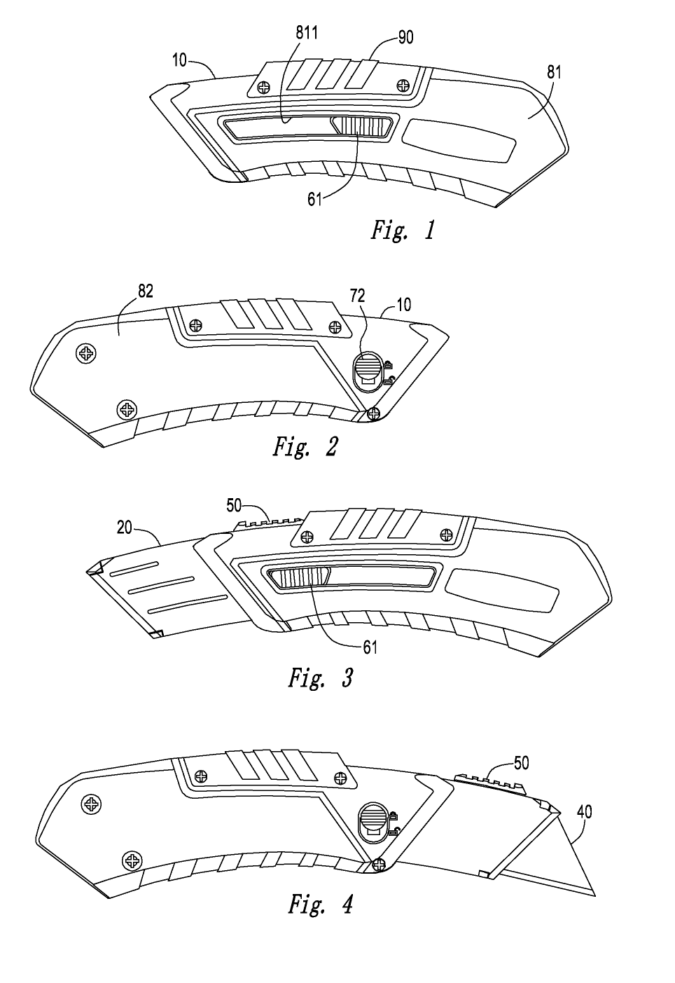

With reference to FIGS. 1 through 5, the preferred embodiment of a retractable telescoping utility knife of the invention is shown. The utility knife has a handle 10 made up of a first cover 11 and a second cover 12 detachably coupling together, a blade shell 20 telescopically skiable contained in the handle 10 and having a first shell 21 and a second shell 22 detachably coupling together, a blade seat 30 slidably contained in the blade shell 20, a blade 40 installed on the blade seat 30, an actuator 50 formed on the blade seat 30, a blade shell control mechanism 60, and a blade change means 70. The handle 10 acts as both a container for the blade shell 20 and a handle of the utility knife.

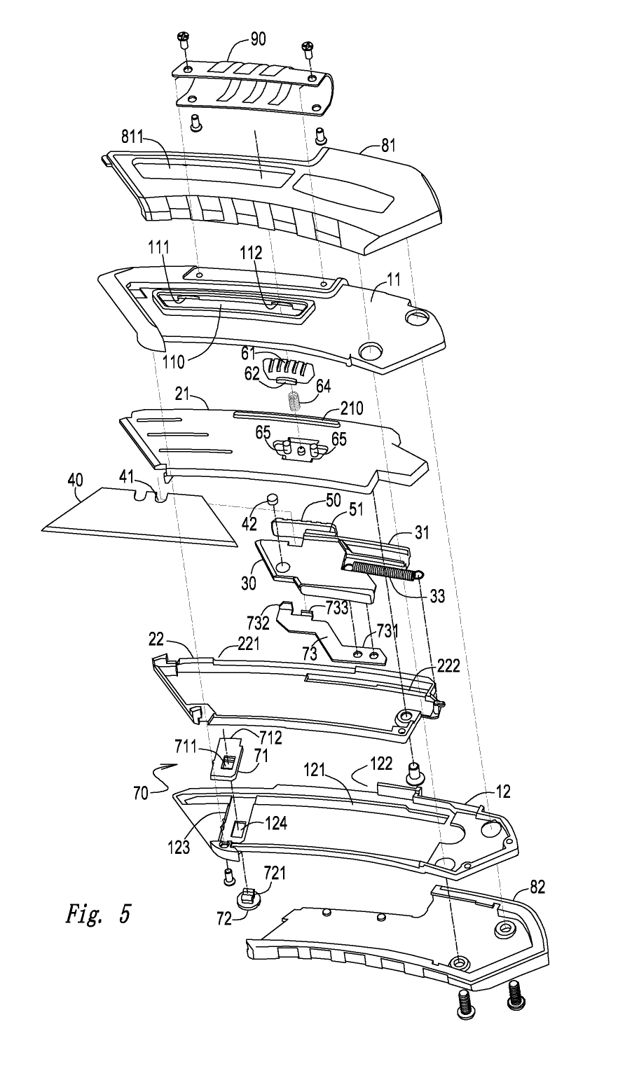

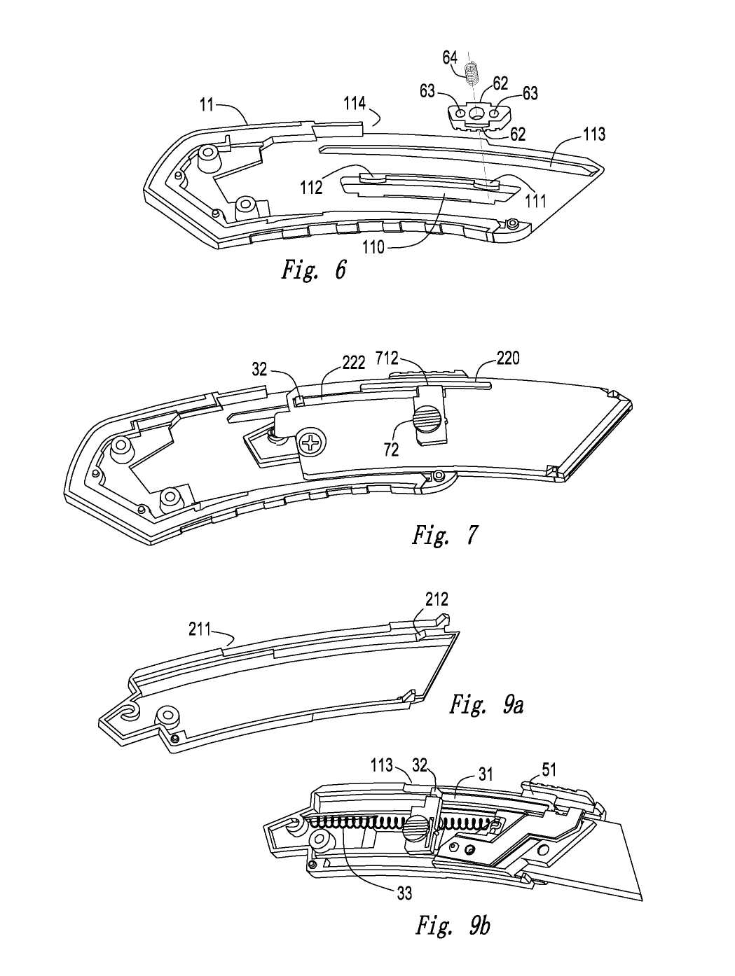

Together with reference to FIG. 6, the first cover 11 has a longitudinal side opening 110 with at least one front recess 111 and at least one rear recess 112, a first inner guiding groove 113, and a first top opening 114. Back to FIG. 5, the second cover 12 has a second inner guiding groove 121 and a second top opening 122. Specifically with reference to FIGS. 5 and 9a, the first shell 21 has a first outer guiding bar 210 which is slidably received in the first inner guiding groove 113 of the first cover 11, a first top slit 211, and a front inner slope 212. Particularly with reference to FIGS. 5 and 7, the second shell 22 has a second outer guiding bar 220 which is slidably received in the second inner guiding groove 121 of the second cover 12, a second top slit 221, and a side slit 222.

As shown in FIGS. 5, 7, and 9b, the blade seat 30 has a rear tail 31, a side protrusion 32 sticking out of the side slit 222, and a blade seat return spring 33 one end thereof is fixed to the blade seat 30 and the other end thereof is fixed to an inner surface of the blade shell 20. The blade 40 is a conventional trapezoidal utility blade having two identical notches 41 for installation.

As shown in FIGS. 5, 8b, and 9b, the actuator 50 has a neck 51 securely being formed on the blade seat 30 and slidable along a top inner house slit defined by the first top slit 211 and the second top slit 221 after the first shell 21 and the second shell 22 are coupled together. As shown in FIGS. 1, 5, and 6, the blade shell control mechanism 60 has a button 61 with at least one ear 62 which is able to be received in the front recess 111 and the rear recess 112 and a pair of positioning holes 63, a resilient member 64 between the button 61 and the first shell 21, and a pair of positioning poles 65 formed on an outer surface of the first shell 21 and each slidably received in one of the positioning holes 63.

With reference to FIGS. 2 and 5, the blade changing means 70 has a cross guiding groove 123 defined in an inner surface of the second cover 12 and crossing to the second inner guiding groove 121, a cross slit 124 defined in the second cover 12 within the cross guiding groove 123, a latch 71 slidable along the cross guiding groove 123 and having a central slit 711 and a top end 712, a latch button 72 having a pair of resilient, legs 721 with hooks, and a blade installation plate 73. The legs 721 of the latch button 72 is able to be inserted through the cross slit 124 and the central slit 711 and then firmly engages with the latch 71. A user is able to move the latch button 72 with his finger along the cross slit 124 between an upper most and a lower most positions. The latch 71, engaged with the latch button 72, will then be driven to move between an upper most and a lower most positions, accordingly. The blade installation plate 73 has a rear end 731 which is fixed to the blade seat 30 and a front end having a side finger 732 and a blade installation pillar 733 which is able to engage with the notch 41 of the blade 40 in installation. The blade installation plate 73 is made of hard material having a certain elasticity, e.g., steel.

In use, as shown FIGS. 2, 3 and 7, a user is able to move the latch button 72 to the upper most position first. The user can push the button 61 inward against the resilient member 64 until the ear 62 leaves the rear recess 112 and then move the button 61 forward along the longitudinal side opening 110 until the car 62 enters the front recess 111. After the user release the button 61, the blade shell 20 extends out from the handle 10 and is locked there by the button 61 with the ear 62 thereof being received in the front recess 111. As the blade shell 20 moves, the actuator 50 moves accordingly forward along an opening defined by the first and the second top opening 114 and 122.

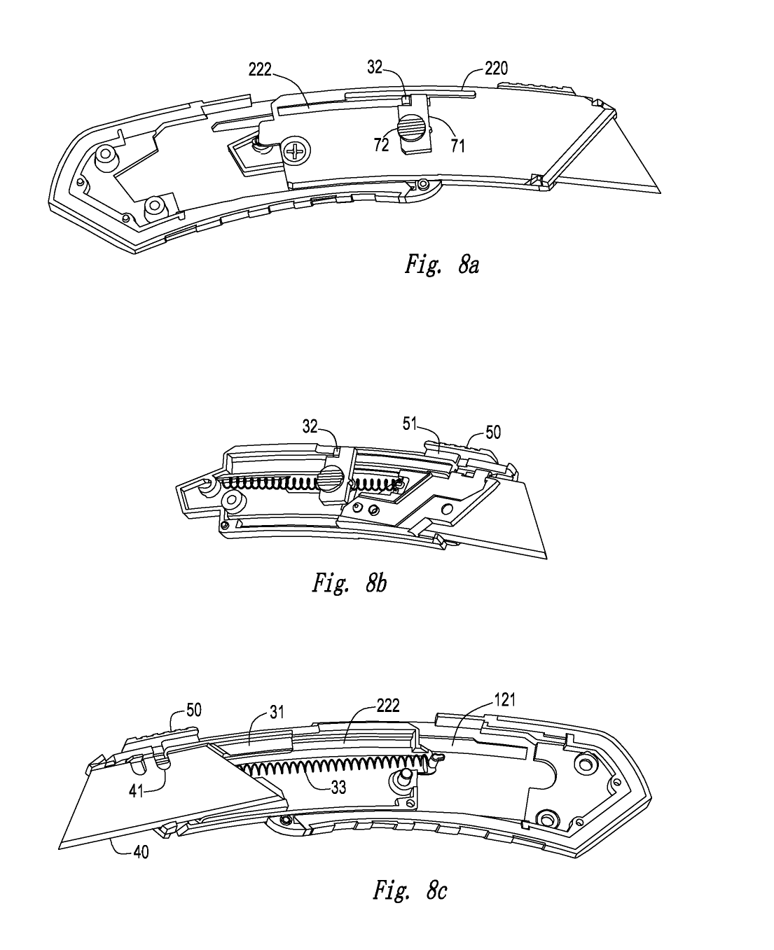

With reference to FIGS. 4, 8a, 8b, and 8c, after the blade shell 20 extends, the user is able to move the actuator 50 forward. The blade seat 30, with the blade 40 installed thereon, will be driven to move forward accordingly against the blade seat return spring 33. When the blade seat 30 moves, the side protrusion 32 thereof moves along the side slit 222 accordingly. The user is able to keep moving the actuator 50 until a work position at which the side protrusion 32 meets and is stopped by the latch 71, as particularly shown in FIGS. 8a and 8b. If the user release the actuator 50, the blade seat 30, with the blade 40 installed thereon, will retract into the blade shell 20 under a force from the blade seat return spring 33.

As shown in FIGS. 9a and 9b, in order to change the blade 40, the user is able to move the latch button 72 to the lower most position first. The latch 71 moves downward accordingly out from the side slit 222. The user will be able to push the actuator 50 to a frontmost blade change position. In the process of pushing the actuator 50 to the blade change position, the side forger 732 of the blade installation plate 73, which has a certain elasticity, will meet and then go along the front inner slope 212 of the first shell 21 and thus push the front end of the blade installation plate 73 to deflect away from the blade scat 30 and the blade 40. When the actuator 50 is pushed to the change position, the deflection of the front end of the blade installation plate 73 will be just able to make the blade installation pillar 733 leave and disengage with the notch 41 of the blade 40. The blade 40 is then able to be pulled out from the blade seat 30 and replaced. After the replacement, the user is able to release the actuator 50 and then move the latch button 72 upward back to the work position for next uses.

Back to FIG. 5, the utility knife of the invention may further have a finishing cover 80 surrounding the handle 10 for improvement of feeling of grasping The finishing cover may be made of ebonite and have a first half 81 and a second half 82 detachably covering on the handle 10. The first half 81 has a cover longitudinal side opening 811 corresponding to the longitudinal side opening 110 of the first cover 11 through which the button 61 passes. The utility knife of the invention may further have a top cover 90 installed on the handle 10 covering on the opening defined by the first and the second top openings 114 and 122. The top cover 90 is able to keep the user from accessing the actuator 50 when the blade shell 20 retracts into the handle 10 to avoid accidently pushing the blade 40 out of the blade shell 20 by inadvertently moving the actuator 50. As shown in the Fig., a magnet 42 may be fixedly installed on the blade seat 30 on a surface facing the blade 40. The magnet 42 is able to make the blade 40, which is ferrous, stabler with respect to the blade seat 30.

From above description, it could be seen that the telescoping utility knife of the above disclosed invention has such a blade 40 that is able to retract into the telescopic blade shell 20 after the user releases the actuator 50 and that is able to be changed easily by simply pushing the actuator 50 to a frontmost position and then pulling out the blade 40. The telescoping utility knife of the invention provides a safer and more efficient knife for users.

What is claimed is:

1. A retractable telescoping utility knife comprising:
a handle having a first cover and a second cover detachably coupling together, a blade shell telescopically slidable contained in the handle and having a first shell and a second shell detachably coupling together, a blade seat slidably contained in the blade shell, a blade having installation notches and installed on the blade seat, an actuator having a neck formed on the blade seat, a blade shell control mechanism, and a blade change means;
the first cover having a longitudinal side opening with at least one front recess and at least one rear recess, a first inner guiding groove, and a first top opening;
the second cover having a second inner guiding groove and a second top opening;
the first shell having a first outer guiding bar which is slidably received in the first inner guiding groove of the first cover, a first top slit, and a front inner slope;
the second shell having a second outer guiding bar which is slidably received in the second inner guiding groove of the second cover, a second top slit, and a side slit;
the blade seat having a rear tail, a side protrusion sticking out of the side slit, and a blade seat return spring one end thereof is fixed to the blade seat and the other end thereof is fixed to an inner surface of the blade shell;
the blade shell control mechanism having a button with at least one ear received in the front recess and the rear recess and a pair of positioning holes, a resilient member between the button and the first shell, and a pair of positioning poles formed on an outer surface of the first shell and each slidably received in one of the positioning holes;
the blade changing means having a cross guiding groove defined in an inner surface of the second cover and cross to the second inner guiding groove, a cross slit defined in the second cover within the cross guiding groove, a latch slidable along the cross guiding groove and having a central slit, a latch button having a pair of resilient legs, and a blade installation plate;
the blade installation plate having a rear end fixed to the blade seat and a front end having a side finger and a blade installation pillar which is able to engage with the notch of the blade.

2. The retractable telescoping utility knife as claimed in claim 1, wherein said utility knife further has a finishing cover having a first half and a second half detachably covering of said handle; the first half has a cover longitudinal side opening corresponding to said longitudinal side opening of said first cover.

3. The retractable telescoping utility knife as claimed in claim 1, wherein said utility knife further has a top cover installed on said handle covering on an opening defined by said first and said second top openings.

4. The retractable telescoping utility knife as claimed in claim 2, wherein said utility knife further has a top cover installed on said handle covering on an opening defined by said first and said second top openings.
